(19) United States
(12) Patent Application Publication
(10) Pub. No.: US 2026/0218635 A1
(43) Pub. Date: Jul. 30, 2026

(54) AIR-OIL SEPARATION SYSTEM FOR AN OIL SUMP IN A GAS TURBINE ENGINE

(71) Applicant: General Electric Company, Evendale, OH (US)

(72) Inventors: Eyitayo James Owoeye, Houston, TX (US); Ravindra Shankar Ganiger, Bengaluru (IN)

(21) Appl. No.: 19/036,715

(22) Filed: Jan. 24, 2025

(51) Int. Cl. F01M 11/03; B01D 19/00; F02C 7/06; F02C 7/14

(52) U.S. Cl. CPC F01M 11/03; B01D 19/0047; B01D 19/0057; F02C 7/06; F02C 7/14; F01M 2011/038; F05D 2260/98

(57) ABSTRACT

An air-oil separation system for an oil sump in a gas turbine engine includes (a) an air-oil separator arranged to separate an air-oil mixture into an oil component and into an air component, (b) at least one air-oil inlet portion arranged to input the air-oil mixture from an oil sump into an separation chamber of the air-oil separator, the air-oil inlet portion including an inlet heat exchanger portion having an inlet coolant flow passage arranged to provide a flow of a coolant therethrough to cool the air-oil mixture input into the air-oil inlet portion, (c) at least one oil outlet arranged to provide the oil component to flow from the separation chamber of the air-oil separator to the oil sump, and (d) an air outlet arranged to provide the air component to flow out of the separation chamber of the air-oil separator.

### TECHNICAL FIELD

The present disclosure relates to an air-oil separation system for an oil sump in a gas turbine engine.

### BACKGROUND

Gas turbine engines are known to include a low-pressure compressor and a low-pressure turbine driven by a low-pressure shaft, and to include a high-pressure compressor and a high-pressure turbine driven by a high-pressure shaft. Both the low-pressure shaft and the high-pressure shaft are supported by bearings that are lubricated by oil within an oil sump. In some gas turbine engines, an air-oil separator may be provided to separate air and oil from an air-oil mixture within the oil sump, and to provide the separated oil back into the sump, while discharging the separated air from the oil sump.

### BRIEF DESCRIPTION OF THE DRAWINGS

Features and advantages of the present disclosure will be apparent from the following description of various exemplary embodiments, as illustrated in the accompanying drawings, wherein like reference numbers generally indicate identical, functionally similar, and/or structurally similar elements.

FIG. 1 is a schematic, partial cross-sectional side view of an exemplary high by-pass turbofan jet engine, according to an aspect of the present disclosure.

FIG. 2 is an enlarged, detail view of a portion of the engine of FIG. 1, taken at detail 74 of FIG. 1, according to an aspect of the present disclosure.

FIG. 3 is a detail view of an air-oil separation system of FIG. 2, according to an aspect of the present disclosure.

FIG. 4 is an enlarged, cross-sectional detail view of an air-oil inlet portion, taken at detail 114 of FIG. 3, according to an aspect of the present disclosure.

FIG. 5 is an aft-looking view of the air-oil separation system of FIG. 3, taken at view 5-5 of FIG. 3, according to an aspect of the present disclosure.

FIG. 6 is a cross-sectional view through the air-oil inlet portion, taken at plane 6-6 of FIG. 4, according to an aspect of the present disclosure.

FIG. 7 is a forward-looking view of the air-oil separation system of FIG. 3, taken at view 7-7 of FIG. 3, according to an aspect of the present disclosure.

FIG. 8A is a partial, aft-looking cross-sectional view through a portion of a separator housing of FIG. 3, taken at plane 8-8 of FIG. 3, according to an aspect of the present disclosure.

FIG. 8B depicts an alternate arrangement of the portion of the separator housing to that shown in FIG. 8A, according to an aspect of the present disclosure.

FIG. 8C depicts an alternate arrangement of the portion of the separator housing to that shown in FIG. 8B, according to an aspect of the present disclosure.

FIG. 8D depicts an alternate arrangement of the portion of the separator housing to that shown in FIG. 8A, according to an aspect of the present disclosure.

FIG. 9 is a partial, cross-sectional side view of the separator housing of FIG. 8B, taken at plane 9-9 of FIG. 8B, according to an aspect of the present disclosure.

FIG. 10 is a partial, cross-sectional side view of the separator housing of FIG. 8C, taken at plane 10-10 of FIG. 8C, according to an aspect of the present disclosure.

FIG. 11 depicts a side view of an alternate air-oil separation system to the air-oil separation system depicted in FIG. 3, according to an aspect of the present disclosure.

FIG. 12 is a partial, cross-sectional, aft-looking view of a portion of the alternate separator housing of FIG. 11, taken at plane 12-12 of FIG. 11, according to an aspect of the present disclosure.

FIG. 13 is a side view of an alternate air-oil separation system that shown in FIG. 3, according to an aspect of the present disclosure.

FIG. 14 is an enlarged, partial cross-sectional, detail view of an inner first wall portion of FIG. 13, taken at detail 224 of FIG. 13, according to an aspect of the present disclosure.

FIG. 15 is a schematic, block diagram of an architecture for implementing an air-oil separation system with air implemented as a coolant, according to an aspect of the present disclosure.

FIG. 16 is a schematic, block diagram of an architecture for implementing an air-oil separation system with fuel implemented as the coolant, according to an aspect of the present disclosure.

FIG. 17 is a schematic, block diagram of an architecture for implementing an air-oil separation system with oil implemented as the coolant, according to an aspect of the present disclosure.

### DETAILED DESCRIPTION

Features, advantages, and embodiments of the present disclosure are set forth, or apparent from, a consideration of the following detailed description, drawings, and claims. Moreover, the following detailed description is exemplary and intended to provide further explanation without limiting the scope of the disclosure as claimed.

Various embodiments are discussed in detail below. While specific embodiments are discussed, this is done for illustration purposes only. A person skilled in the relevant art will recognize that other components and configurations may be used without departing from the present disclosure.

As used herein, the terms “first” and “second” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

Gas turbine engines are known to include a low-pressure compressor and a low-pressure turbine driven by a low-pressure shaft, and to include a high-pressure compressor and a high-pressure turbine driven by a high-pressure shaft. Both the low-pressure shaft and the high-pressure shaft are supported by bearings that are lubricated by oil within an oil sump. In some gas turbine engines, an air-oil separator may be provided to separate air and oil from an air-oil mixture within the oil sump, and to provide the separated oil back into the sump, while discharging the separated air. Some conventional air-oil separators, however, may not efficiently separate the oil from the air, resulting in oil particles being discharged with the air from the air-oil separator. As a result, a higher consumption of the engine oil occurs, and the engine oil may also not be sufficiently cooled within the oil sump to provide efficient lubrication of the bearings.

The present disclosure aims to address the foregoing by incorporating a heat exchanger within the air-oil separator so as to provide better cooling of the air-oil mixture within the air-oil separator. The cooling of the air-oil mixture within the air-oil separator increases the density difference between oil molecules and air molecules, which allows the oil molecules to coalesce into larger droplets, thereby increasing the ease of separation.

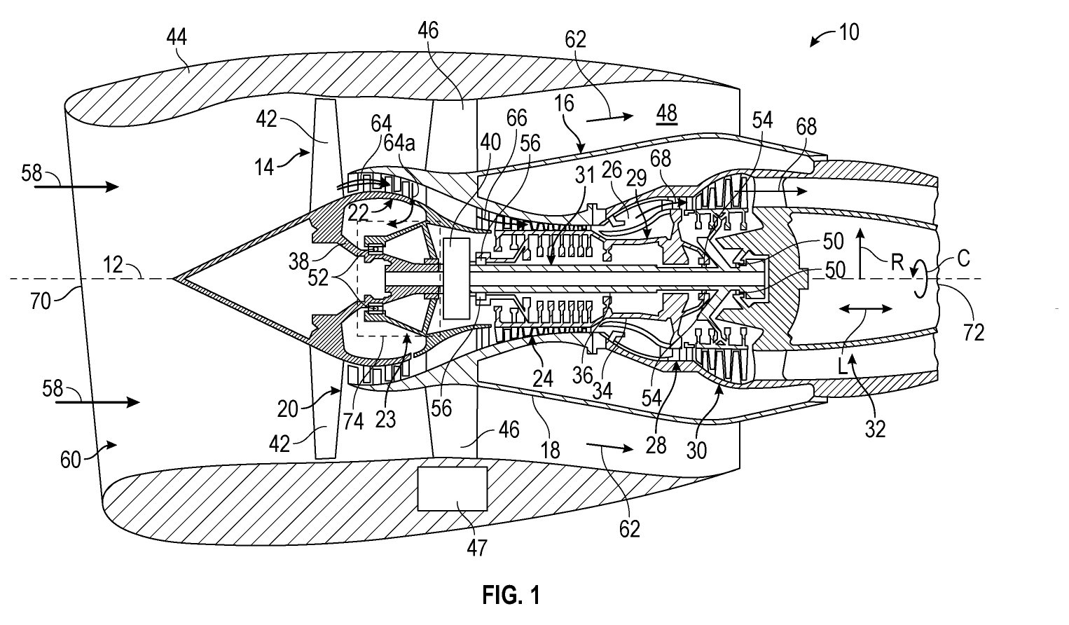

Referring now to the drawings, FIG. 1 is a schematic, cross-sectional side view of an exemplary high by-pass turbofan jet engine 10, herein referred to as “engine 10,” as may incorporate various embodiments of the present disclosure. Although further described below with reference to a ducted turbofan engine, the present disclosure is also applicable to gas turbine engines in general, or to turbomachinery in general, including turbojet, turboprop, and turboshaft gas turbine engines, including marine and industrial turbine engines (which may also be referred to as aeroderivative gas turbine engines) and auxiliary power units. In addition, the present disclosure is not limited to ducted fan type turbine engines, such as that shown in FIG. 1, but can be implemented in unducted fan (UDF) type turbine engines. As shown in FIG. 1, engine 10 has a longitudinal centerline axis 12 that extends therethrough from an upstream end 70 of the engine 10 to a downstream end 72 of the engine 10 for reference purposes. The longitudinal centerline axis 12 may define a longitudinal direction (L) of the engine 10, while a radial direction (R) extends outward from the longitudinal centerline axis 12, and a circumferential direction C extends about the longitudinal centerline axis 12.

In general, engine 10 may include a fan assembly 14 and a turbo-engine 16 disposed downstream from the fan assembly 14. The turbo-engine 16 may generally include an outer casing 18 that defines an annular inlet 20. The outer casing 18 encases, or at least partially forms, in serial flow relationship, a compressor section having a low-pressure (LP) compressor 22, a high-pressure (HP) compressor 24, a combustor 26, a turbine section including a high-pressure turbine 28 and a low-pressure turbine 30, and a jet exhaust nozzle section 32. A high-pressure rotor shaft 34 drivingly connects the HP turbine 28 to the HP compressor 24, and, together, the HP compressor 24, the HP turbine 28, and the HP rotor shaft 34 define a high-pressure spool 29. A low pressure (LP) rotor shaft 36 drivingly connects the LP turbine 30 to the LP compressor 22, and, together, the LP compressor 22, the LP turbine 30, and the LP rotor shaft 36 define a low-pressure spool 31. The LP rotor shaft 36 may also be connected to a fan shaft 38 of the fan assembly 14 by way of a reduction gearbox assembly 40 (shown generally), such as in a geared drive or an indirect drive configuration. The LP rotor shaft 36, and, thus, the low-pressure spool 31 is supported by an LP shaft aft bearing 50 and an LP shaft forward bearing 52. Similarly, the HP rotor shaft 34 is supported by an HP shaft aft bearing 54 and an HP shaft forward bearing 56. As will be described in more detail below, each of the LP shaft aft bearing 50, the LP shaft forward bearing 52, the HP shaft aft bearing 54, and the HP shaft forward bearing 56 may be arranged within an oil sump (not shown in FIG. 1) that provides a flow of oil to lubricate the bearings.

The engine 10 may also include an accessory gearbox 47. While not shown in FIG. 1, the accessory gearbox 47 may be mechanically connected via a drive shaft (not shown) extending through one of the struts 46 to an intermediate gearbox (not shown) that is driven by the high-pressure spool 29. The high-pressure spool 29 drives the accessory gearbox 47 to thereby drive various accessories (not shown) which may be mounted to the accessory gearbox 47. For example, one or more hydraulic pumps and one or more oil pumps may be mounted to, and driven by, the accessory gearbox 47.

As shown in FIG. 1, the fan assembly 14 includes a plurality of fan blades 42 that are coupled to, and extend radially outwardly from, the fan shaft 38. An annular fan casing or a nacelle 44 circumferentially surrounds the fan assembly 14, or at least a portion of the turbo-engine 16, or both. The nacelle 44 may be supported relative to the turbo-engine 16 by a plurality of circumferentially spaced outlet guide vanes or struts 46. Moreover, at least a portion of the nacelle 44 may extend over an outer portion of the turbo-engine 16 so as to define a bypass airflow passage 48 therebetween.

In operation, air 58 enters the nacelle 44 at a nacelle inlet 60, and a portion of the air 58 enters the annular inlet 20 as a compressor inlet air flow 64, where the compressor inlet air flow 64 is compressed by the LP compressor 22 and the HP compressor 24 to form compressed air 66. Another portion of the air 58 enters the fan assembly 14 and is propelled by the fan blades 42 into the bypass airflow passage 48, thereby providing a bypass airflow 62. The compressed air 66 from the HP compressor 24 enters the combustor 26, where the compressed air 66 is then mixed with fuel to generate a fuel and air mixture that is ignited and burned within the combustor 26 to generate combustion gases 68. The combustion gases 68 then flow further downstream into the HP turbine 28 and into the LP turbine 30, thereby causing the HP rotor shaft 34 and the LP rotor shaft 36 to rotate. The rotation of the LP rotor shaft 36 also causes the fan shaft 38 to rotate via the reduction gearbox assembly 40. The combustion gases 68 then exit through the jet exhaust nozzle section 32.

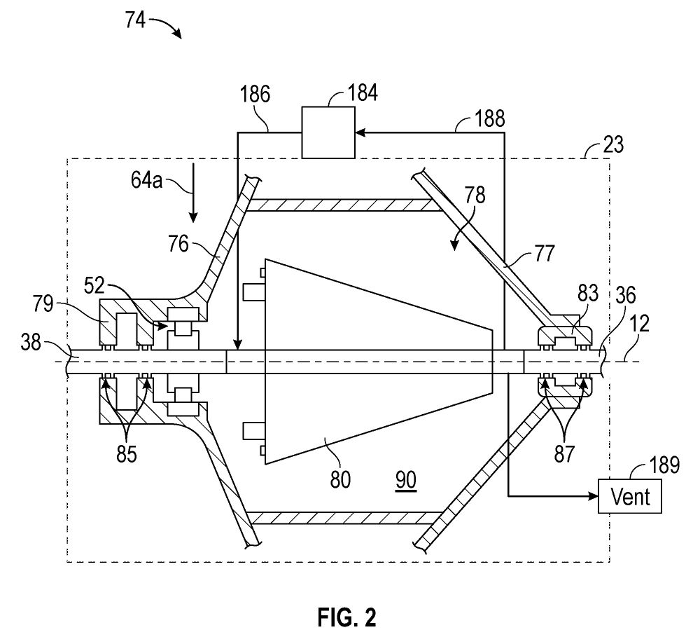

FIG. 2 is an enlarged, detail view of a portion of the engine of FIG. 1, taken at detail 74 of FIG. 1, according to an aspect of the present disclosure. As shown in FIG. 2, a bearing support structure 76 supports the LP shaft forward bearing 52, and a shaft support member 77 is connected with the bearing support structure 76 and supports the LP rotor shaft 36. While one LP shaft forward bearing 52 is shown in FIG. 2, more than one LP shaft forward bearing 52 may be included instead. The bearing support structure 76 and the shaft support member 77 define an oil sump 78 that retains oil (not shown) to be provided to the LP shaft forward bearing 52 for lubrication. The oil sump 78 is provided within the pressurized air cavity 23 (shown generally in FIG. 2), and a pressurized air cavity 23 is pressurized by, for example, a compressor bleed air 64a. The bearing support structure 76 may include a forward oil sump seal portion 79, and the shaft support member 77 may include an aft oil sump seal portion 83. The forward oil sump seal portion 79 engages with one or more shaft seals 85 that may be formed as part of the fan shaft 38, for example. The shaft seals 85 may be, for example, labyrinth seals, or any other type of carbon air and oil seal. Similarly, the shaft support member 77 includes an aft oil sump seal portion 83 that engages with one or more shaft seals 87 that may be formed as part of the LP rotor shaft 36, for example. The shaft seals 87 may also be labyrinth seals or any other type of carbon air and oil seal. The shaft seals 85 and the shaft seals 87 function to seal the oil sump 78 so that oil does not leak out of the oil sump 78 due to a higher pressure within the pressurized air cavity 23 than a pressure within the oil sump 78. However, the shaft seals 85 and the shaft seals 87 may have some leakage therethrough in which some of the compressor bleed air 64a within the pressurized air cavity 23 may leak into the oil sump 78, thereby resulting in an air-oil mixture 90 (shown generally) in the oil sump 78. An air-oil separation system 80 is provided within the oil sump 78, and, as will be described in more detail below, at least a portion of the air-oil separation system 80 is driven by the LP rotor shaft 36 such that the air-oil separation system 80 is a centrifugal air-oil separator to separate air from the oil in the air-oil mixture 90. As will be described in more detail below, a coolant supply source 184 provides a flow of a coolant to the air-oil separation system 80 via a coolant supply line 186, and receives a flow of the coolant from the air-oil separation system 80 via a coolant return line 188. In some aspects, as will be described below, the coolant may be provided to other components of the engine 10 instead of returning to the coolant supply source 184 via the coolant return line 188. In addition, as will be described below, air that is separated out from the air-oil mixture 90 may be vented out of the engine 10 (FIG. 1) via a vent 189.

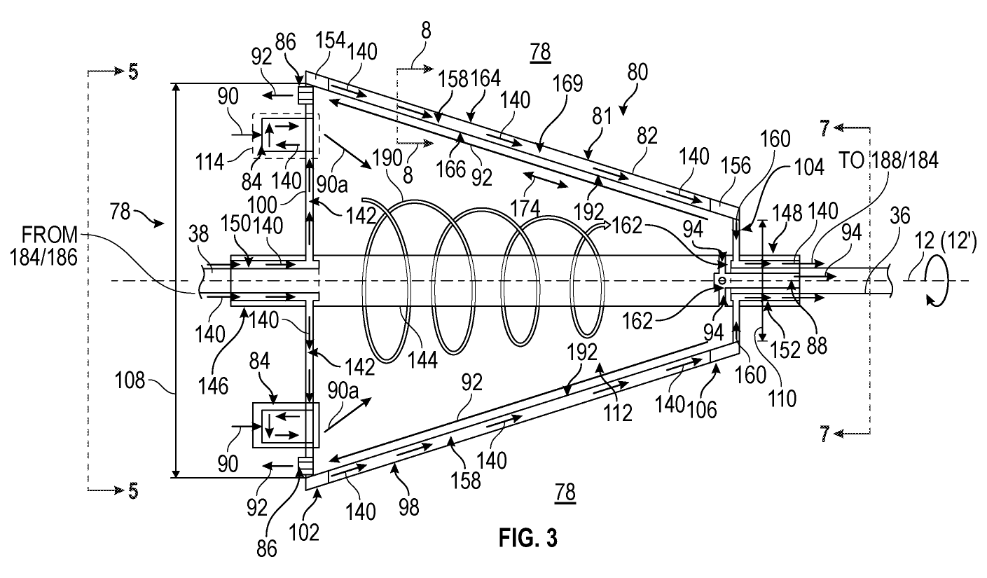

FIG. 3 is a detail view of the air-oil separation system 80 of FIG. 2, according to an aspect of the present disclosure. In FIG. 3, the bearing support structure 76 (FIG. 2) is omitted and the oil sump 78 is represented generally as surrounding the air-oil separation system 80 by reference numeral 78. The air-oil separation system 80 includes an air-oil separator 81 having a separator housing 82, a first end wall 100, a second end wall 104, and a separator shaft 144. The separator housing 82, the first end wall 100, and the second end wall 104 define a separation chamber 112. As will be described in more detail below, the air-oil separator 81 is arranged to separate the air-oil mixture 90 into an oil component 92 (e.g., deaerated oil molecules) and into an air component 94 (e.g., deoiled air molecules). The air-oil separation system 80 also includes at least one air-oil inlet portion 84 that is arranged to input the air-oil mixture 90 from the oil sump 78 into the separation chamber 112. As will be described in more detail below, the air-oil inlet portion 84 includes a heat exchanger portion (described below) arranged to provide a flow of a coolant therethrough to cool the air-oil mixture 90 input into the air-oil inlet portion 84. The air-oil separation system 80 further includes at least one oil outlet 86 arranged to provide the oil component 92 to flow from the separation chamber 112 to the oil sump 78, and an air outlet 88 arranged to provide the air component 94 to flow out of the separation chamber 112 to the vent 189 (FIG. 2).

In FIG. 3, the separator housing 82 includes a frusto-conical wall 98 that includes at least one housing wall coolant flow passage 158. The housing wall coolant flow passage 158 will be described in more detail below. The first end wall 100 is arranged at a first end 102 of the frusto-conical wall 98, and the second end wall 104 is arranged at a second end 106 of the frusto-conical wall 98. The first end wall 100 extends circumferentially about a longitudinal centerline axis 12´ and has a first diameter 108. The at least one air-oil inlet portion 84 extends through the first end wall 100 so as to provide the flow of the air-oil mixture 90 therethrough into the separation chamber 112. The second end wall 104 also extends circumferentially about the longitudinal centerline axis 12´ and has a second diameter 110, where the second diameter 110 is less than the first diameter 108. As will be described below, the air-oil mixture 90 enters the separation chamber 112 via the air-oil inlet portion 84, and the air-oil mixture 90 is separated within the separation chamber 112 into the oil component 92 and the air component 94.

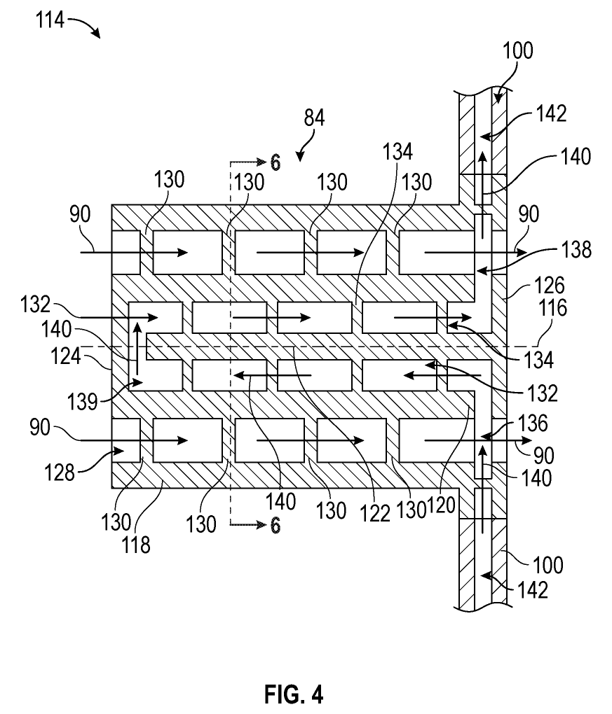

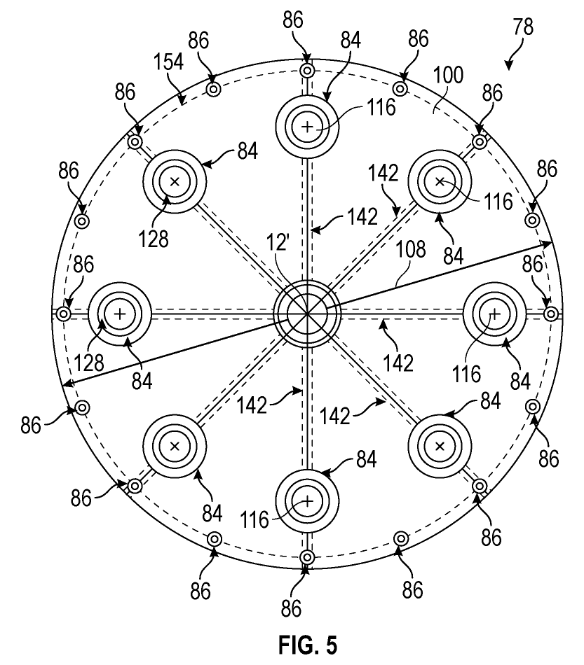

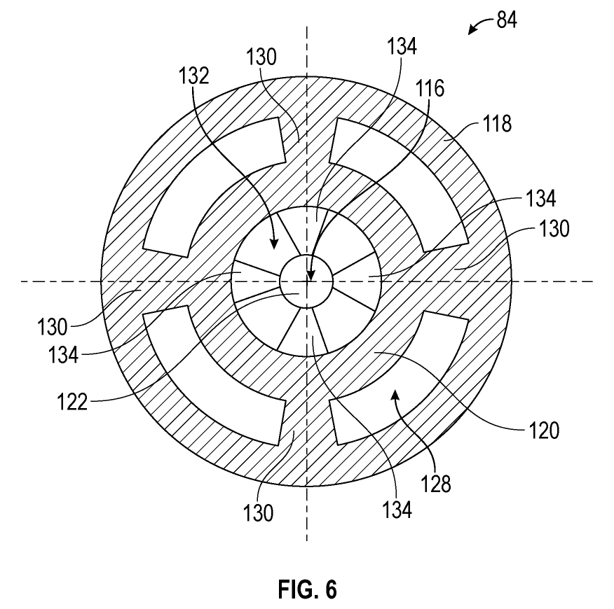

FIG. 4 is an enlarged, cross-sectional, detail view of the air-oil inlet portion 84, taken at detail 114 of FIG. 3, according to an aspect of the present disclosure. FIG. 5 is an aft-looking view of the air-oil separation system 80, taken at view 5-5 of FIG. 3, according to an aspect of the present disclosure. FIG. 6 is a cross-sectional view through the air-oil inlet portion 84, taken at plane 6-6 of FIG. 4, according to an aspect of the present disclosure. Referring collectively to FIG. 4, to FIG. 5, and to FIG. 6, the air-oil inlet portion 84 may be cylindrical and have an inlet centerline axis 116. As shown in FIG. 4, the air-oil inlet portion 84 includes a cylindrical outer wall 118, a cylindrical inner wall 120, a cylindrical core 122, a first inlet end wall 124, and a second inlet end wall 126. An air-oil mixture inlet passage 128 is defined between the cylindrical outer wall 118 and the cylindrical inner wall 120, and the air-oil mixture 90 flows through the air-oil mixture inlet passage 128 from the oil sump 78 (FIG. 3) into the separation chamber 112 (FIG. 3). As shown in FIG.4 and in FIG. 6, a plurality of air-oil passage supports 130 are arranged circumferentially spaced apart about the inlet centerline axis 116, and are arranged between the cylindrical outer wall 118 and the cylindrical inner wall 120. As also shown in FIG. 4 and in FIG. 6, an inlet coolant flow passage 132 is defined between the cylindrical inner wall 120 and the cylindrical core 122. A plurality of coolant passage supports 134 are arranged circumferentially spaced apart about the inlet centerline axis 116, and are arranged between the cylindrical inner wall 120 and the cylindrical core 122. A coolant inlet 136 is arranged within the second inlet end wall 126, and is in fluid communication with the inlet coolant flow passage 132, and a coolant outlet 138 is arranged through the second inlet end wall 126 and is in fluid communication with the inlet coolant flow passage 132. A coolant 140 (described below) flows through the coolant inlet 136, through the inlet coolant flow passage 132, and then through the coolant outlet 138. The inlet coolant flow passage 132, therefore, functions as an inlet heat exchanger portion 139 to provide cooling to the air-oil mixture 90 flowing through the air-oil mixture inlet passage 128.

Referring to FIG. 5, and to FIG. 3, a plurality of the air-oil inlet portions 84 are provided through the first end wall 100, and the plurality of air-oil inlet portions 84 may be circumferentially spaced apart from one another about the longitudinal centerline axis 12´. While FIG. 5 depicts eight air-oil inlet portions 84, greater than eight or fewer than eight air-oil inlet portions 84 may be implemented instead. In addition, a plurality of oil outlets 86 are arranged circumferentially spaced apart from each other about the longitudinal centerline axis 12´. As shown in FIG. 3, each oil outlet 86 of the plurality of oil outlets 86 extends through the first end wall 100 and provides fluid communication between the separation chamber 112 and the oil sump 78 to provide a flow of the oil component 92 to flow from the separation chamber 112 to the oil sump 78.

In FIG. 3, the separator shaft 144 is arranged to be rotationally driven about the longitudinal centerline axis 12´ of the air-oil separation system 80. The separator shaft 144 includes a shaft coolant inlet portion 146 and a shaft coolant outlet portion 148. The shaft coolant inlet portion 146 includes a shaft coolant inlet channel 150 and the shaft coolant outlet portion 148 includes a shaft coolant outlet channel 152. The shaft coolant inlet channel 150 receives the flow of the coolant 140 from the coolant supply line 186 (FIG. 2), and the shaft coolant outlet channel 152 provides a flow of the coolant 140 to the coolant return line 188 (FIG. 2). As shown in FIG. 3, and as shown with dashed lines in FIG. 5, the first end wall 100 includes a plurality of first end wall coolant flow passages 142. Each of the plurality of first end wall coolant flow passages 142 is in fluid communication with the shaft coolant inlet channel 150, and with a respective coolant inlet 136 of a respective one of the air-oil inlet portions 84. Thus, the coolant 140 is provided to the shaft coolant inlet channel 150, to the respective ones of the first end wall coolant flow passages 142, and to the respective ones of the air-oil inlet portions 84. In addition, each of the first end wall coolant flow passages 142 is in fluid communication with a housing wall inlet manifold 154. The housing wall inlet manifold 154 may be formed as part of the separator housing 82 and is arranged to receive the coolant 140 from each of the first end wall coolant flow passages 142, and to distribute the coolant 140 to the at least one housing wall coolant flow passage 158.

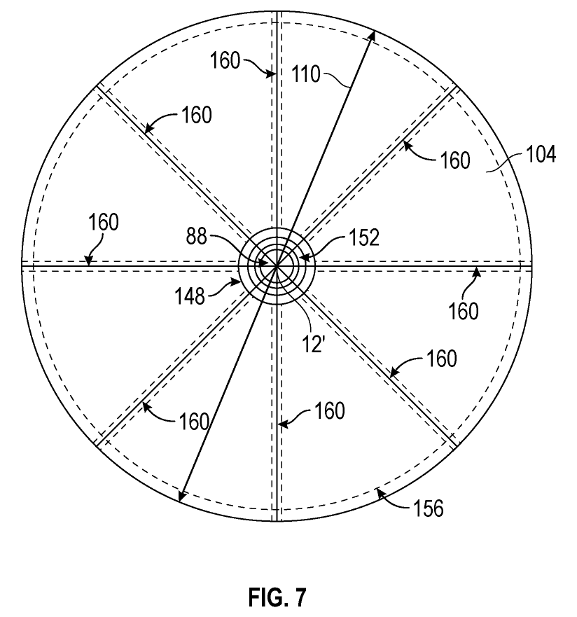

FIG. 7 is a forward-looking view of the air-oil separation system 80, taken at view 7-7 of FIG. 3, according to an aspect of the present disclosure. Referring to FIG. 7, and to FIG. 3, the second end wall includes a plurality of second end wall coolant flow passages 160 (shown with dashed lines in FIG. 7) that are circumferentially spaced apart about the longitudinal centerline axis 12. Each of the second end wall coolant flow passages 160 is in fluid communication with a housing wall outlet manifold 156, which may be formed as part of the separator housing 82, and with the shaft coolant outlet channel 152. The housing wall outlet manifold 156 is arranged to receive the coolant 140 from each of the at least one housing wall coolant flow passages 158, and to distribute the coolant 140 to each of the second end wall coolant flow passages 160. Each of the second end wall coolant flow passages 160 is in fluid communication with the shaft coolant outlet channel 152 to provide the coolant 140 to the shaft coolant outlet channel 152. The separator shaft 144 also includes a plurality of air outlet passages 162 that are arranged to provide a flow of the air component 94 therethrough to flow out of the separation chamber 112 to the vent 189 (FIG. 2).

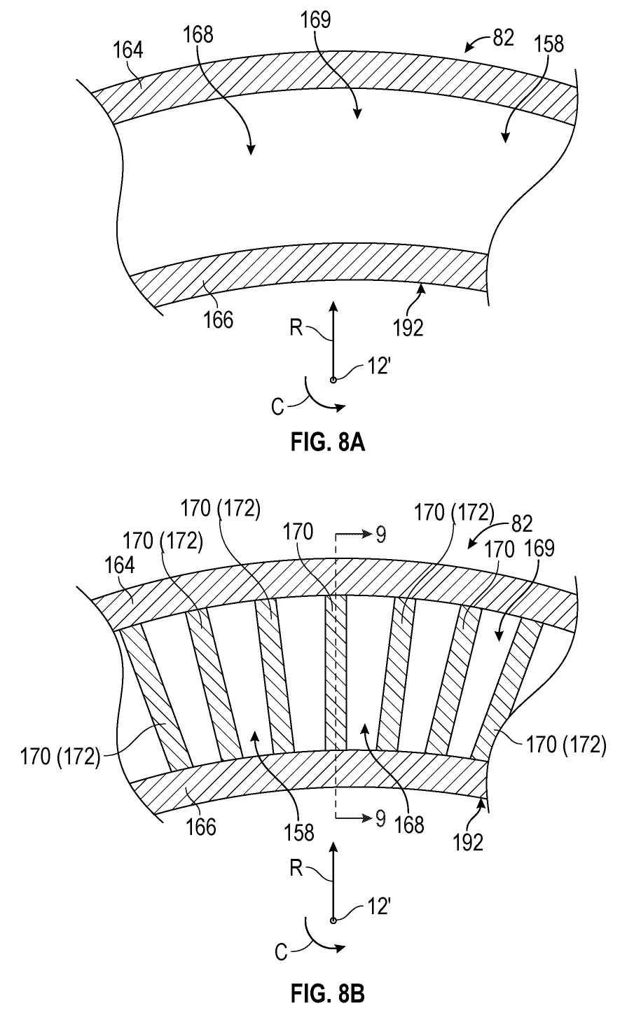

FIG. 8A is a partial, aft-looking cross sectional view through a portion of the separator housing 82 of FIG. 3, taken at plane 8-8 of FIG. 3, according to an aspect of the present disclosure. In FIG. 8A, the separator housing 82 is shown to include a separator housing outer wall 164 and a separator housing inner wall 166, and the at least one housing wall coolant flow passage 158 is arranged between the separator housing outer wall 164 and the separator housing inner wall 166. The housing wall coolant flow passage 158 functions as a separator housing heat exchanger 169. In the aspect of FIG. 8A, the at least one housing wall coolant flow passage 158 is shown to be a single housing wall coolant flow passage 168 that extends in the circumferential direction C about the longitudinal centerline axis 12´. While FIG. 8A depicts a portion of the separator housing 82 and a portion of the single housing wall coolant flow passage 168, the single housing wall coolant flow passage 168 extends three hundred sixty degrees about the longitudinal centerline axis 12´, and extends lengthwise from the housing wall inlet manifold 154 (FIG. 3) to the housing wall outlet manifold 156 (FIG. 3). As will be described below, the housing wall coolant flow passage 158 also functions as a heat exchanger portion of the air-oil separation system 80 to providing cooling to the oil component 92 within the oil sump 78, and to provide cooling to the oil component 92 within the separation chamber 112.

FIG. 8B depicts an alternate arrangement of the portion of the separator housing 82 to that shown in FIG. 8A, according to an aspect of the present disclosure. In FIG. 8B, elements that are the same as those of FIG. 8A include the same reference numerals and the description provided above for those elements is also applicable to FIG. 8B. In FIG. 8B, a plurality of heat exchange elements 170 are included within the single housing wall coolant flow passage 168. The plurality of heat exchange elements 170 of FIG. 8B may be, for example, heat exchange posts 172 that are connected to the separator housing outer wall 164 and to the separator housing inner wall 166. The plurality of heat exchange posts 172 may be spaced apart from each other within the single housing wall coolant flow passage 168 in a circumferential direction C with respect to the longitudinal centerline axis 12´.

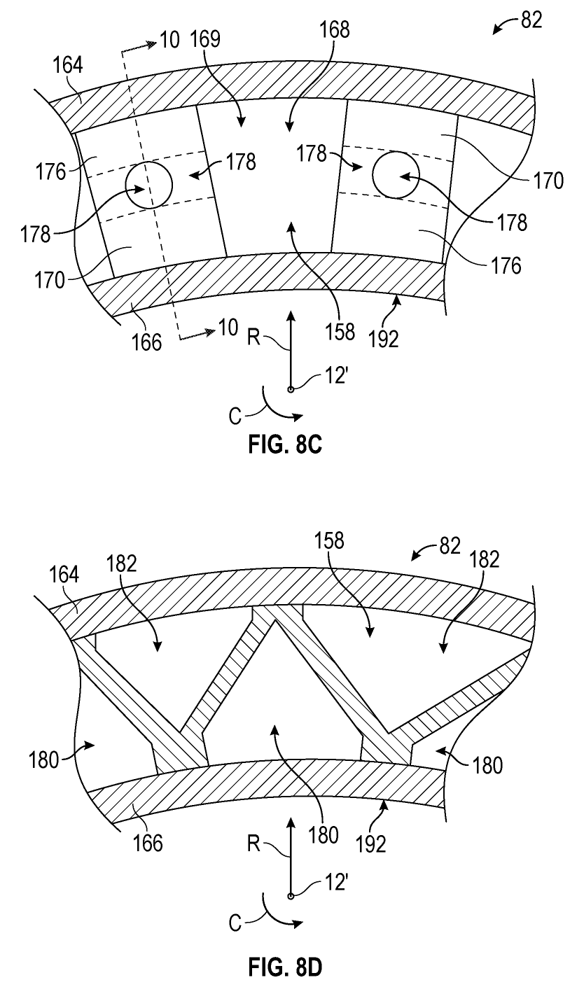

FIG. 9 is a partial, cross-sectional side view of the separator housing 82, taken at plane 9-9 of FIG. 8B, according to an aspect of the present disclosure. As shown in FIG. 9, the plurality of heat exchange posts 172 are also spaced apart from one another in a lengthwise direction 174 (see also, FIG. 3) within the single housing wall coolant flow passage 168. Each of the heat exchange posts 172 increases the cooling efficiency of the single housing wall coolant flow passage 168 by increasing surface area of the separator housing heat exchanger 169.

FIG. 8C depicts an alternate arrangement of the portion of the separator housing 82 to that shown in FIG. 8B, according to an aspect of the present disclosure. In FIG. 8C, elements that are the same as those of FIG. 8B include the same reference numerals and the description provide above for those elements is also applicable to FIG. 8C. In FIG. 8C, the plurality of heat exchange elements 170 are also included within the single housing wall coolant flow passage 168, but the plurality of heat exchange elements 170 of FIG. 8C may be, for example, heat exchange blocks (or unit cells) 176 that are connected to the separator housing outer wall 164 and to the separator housing inner wall 166. The plurality of heat exchange blocks 176 include coolant flow passages 178 therethrough, and may be spaced apart from each other within the single housing wall coolant flow passage 168 in a circumferential direction C with respect to the longitudinal centerline axis 12´.

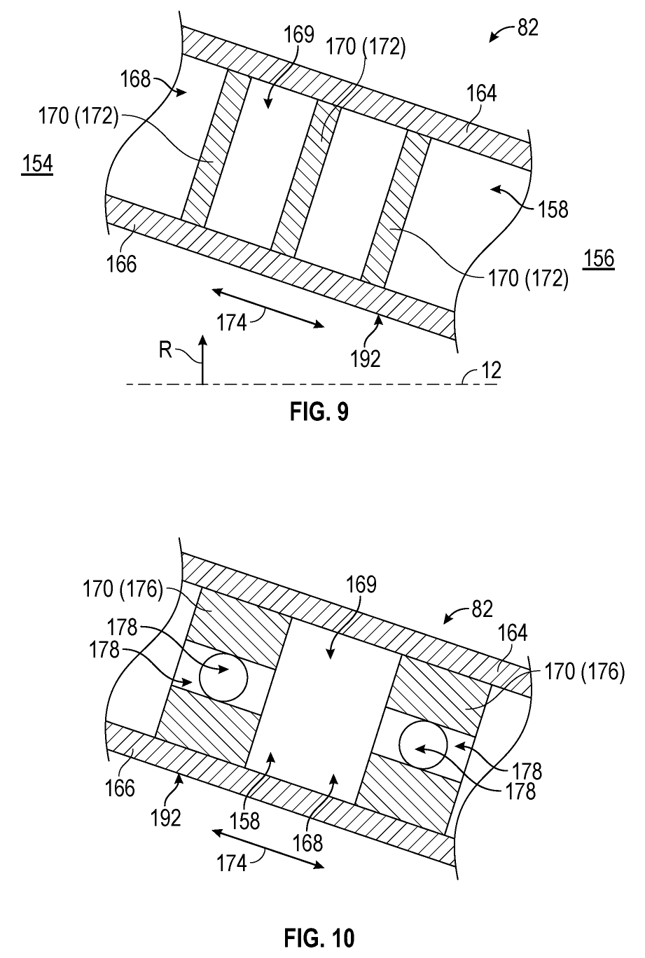

FIG. 10 is a partial, cross-sectional side view of the separator housing 82, taken at plane 10-10 of FIG. 8C, according to an aspect of the present disclosure. As shown in FIG. 10, the plurality of heat exchange blocks 176 are also spaced apart from one another in the lengthwise direction 174 within the single housing wall coolant flow passage 168. Each of the heat exchange blocks 176 increases the cooling efficiency of the single housing wall coolant flow passage 168 by increasing surface area of the separator housing heat exchanger 169.

FIG. 8D depicts an alternate arrangement of the portion of the separator housing 82 to that shown in FIG. 8A, according to an aspect of the present disclosure. In FIG. 8D, elements that are the same as those of FIG. 8A include the same reference numerals and the description provide above for those elements is also applicable to FIG. 8D. In FIG. 8D, the housing wall coolant flow passage 158, rather than being the single housing wall coolant flow passage 168, includes a plurality of housing coolant flow channels, including a plurality of inner housing coolant flow channels 180 and a plurality of outer housing coolant flow channels 182. The housing wall inlet manifold 154 (FIG. 3) can be arranged to provide the coolant 140 to either one of, or to both of, the plurality of inner housing coolant flow channels 180 or the plurality of outer housing coolant flow channels 182. In one aspect of FIG. 8D, the plurality of inner housing coolant flow channels 180 and the plurality of outer housing coolant flow channels 182 may be arranged to extend in the lengthwise direction 174 (FIG. 3) from the housing wall inlet manifold 154 to the housing wall outlet manifold 156 (FIG. 3) in a generally longitudinal direction with respect to the longitudinal centerline axis 12´. That is, the plurality of inner housing coolant flow channels 180 and the plurality of outer housing coolant flow channels 182 may be arranged as straight channels. In another aspect of FIG. 8D, the plurality of inner housing coolant flow channels 180 and the plurality of outer housing coolant flow channels 182 may be arranged as helical channels that extend in the lengthwise direction 174 (FIG. 3), but also extend in a circumferential direction C with respect to the longitudinal centerline axis 12´.

Referring collectively to FIG. 1 to FIG. 10, in operation of the air-oil separation system 80, the air-oil separator 81 is driven by the separator shaft 144 to rotate within the oil sump 78. The air-oil mixture 90 entrapped within the oil sump 78 flows from the oil sump 78 through the air-oil inlet portion 84 into the separation chamber 112 (FIG. 3), and the air-oil mixture 90 is cooled by the coolant 140 flowing through the inlet heat exchanger portion 139 of the air-oil inlet portion 84, resulting in a cooled air-oil mixture 90a (FIG. 3) flowing into the separation chamber 112. The rotation of the air-oil separation system 80 induces a swirl 190 (FIG. 3) within the separation chamber 112 to the cooled air-oil mixture 90a. The centrifugal force of the swirl 190 provides for separation of the cooled air-oil mixture 90a into the oil component 92 and into the air component 94 due to the greater density of the oil molecules within the cooled air-oil mixture 90a. Thus, the swirl 190 results in separating the cooled air-oil mixture 90a to obtain the oil component 92 and to obtain the air component 94. The centrifugal force of the swirl 190 also results in the oil component 92 flowing toward an inner surface 192 (FIG. 3; FIG. 8A) of the separator housing inner wall 166. As shown in FIG. 3, the rotation of the separator housing 82 causes the oil component 92 to flow along the inner surface 192 of the separator housing inner wall 166 toward the at least one oil outlet 86. While flowing along the inner surface 192 of the separator housing inner wall 166, the oil component 92 is further cooled by the coolant 140 flowing through the at least one housing wall coolant flow passage 158. The oil component 92 then flows through the at least one oil outlet 86 to flow out of the separation chamber 112 and into the oil sump 78. The air component 94 flows through the at least one air outlet 88 to flow out of the separation chamber 112 to the vent 189 (FIG. 2).

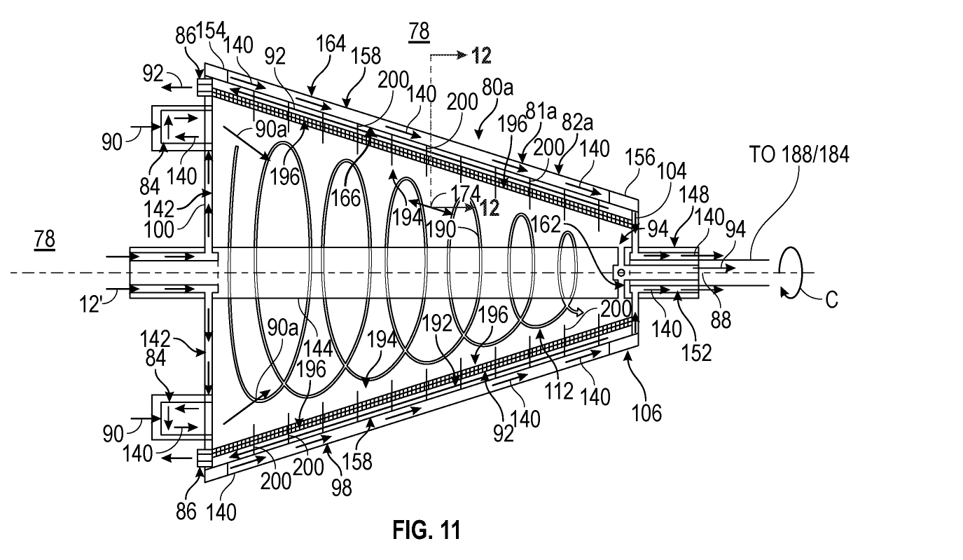

FIG. 11 depicts a side view of an alternate air-oil separation system 80a to the air-oil separation system 80 depicted in FIG. 3, according to an aspect of the present disclosure. In FIG. 11, elements that are the same as those in FIG. 3 include the same reference numerals, and the description of those elements provided above for FIG. 3 is also applicable to FIG. 11. In FIG. 11, the alternate air-oil separation system 80a includes an alternate air-oil separator 81a that has an alternate separator housing 82a. One difference between the separator housing 82 of the FIG. 3 aspect and the alternate separator housing 82a of the FIG. 11 aspect is that the alternate separator housing 82a includes a vane structure 194 that may include one or more vanes 200 extending inward into the separation chamber 112 from the inner surface 192 of the separator housing inner wall 166. In addition, wire mesh elements 196 are arranged between respective vanes 200. As shown in FIG. 11, the wire mesh elements 196 may constitute a plurality of the wire mesh elements 196 arranged in the lengthwise direction 174 between respective ones of the vanes 200. The vanes 200 may be individual vanes that extend circumferentially about the longitudinal centerline axis 12 along the inner surface 192 of the separator housing inner wall 166. Alternatively, the vanes 200 may constitute one or more helical vanes that extend circumferentially about the longitudinal centerline axis 12, and that also extend along the lengthwise direction 174 in a helical manner. The wire mesh elements 196 atomize the cooled air-oil mixture 90a as the cooled air-oil mixture 90a swirls in the separation chamber 112 to further induce separation of the air component 94 from the oil component 92. The vanes 200 guide the cooled air-oil mixture 90a along a predefined flow path (e.g., a helical flow path) as the cooled air-oil mixture 90a swirls, thereby increasing the dwell time of the cooled air-oil mixture 90a in the separation chamber 112 to further increase the separation efficiency.

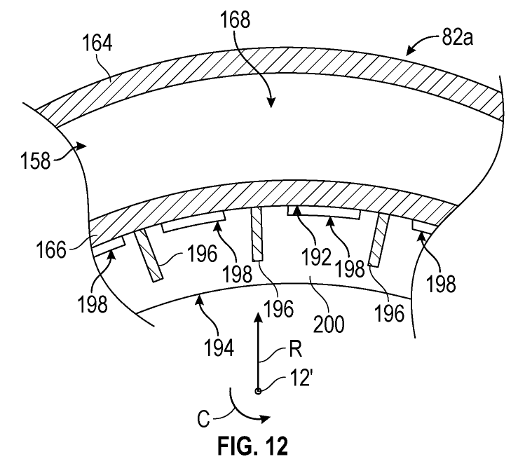

FIG. 12 is a partial cross-sectional, aft-looking view of a portion of the alternate separator housing 82a of FIG. 11, taken at plane 12-12 of FIG. 11, according to an aspect of the present disclosure. As shown in FIG. 12, a plurality of the wire mesh elements 196 are circumferentially spaced apart from one another about the longitudinal centerline axis 12. In addition, each vane 200 may include a plurality of oil component flow openings 198 arranged through each vane 200 along the inner surface 192 of the separator housing inner wall 166. The plurality of oil component flow openings 198 are circumferentially spaced apart from each other and are arranged between respective ones of the wire mesh elements 196. The plurality of oil component flow openings 198 allow the oil component 92 (FIG. 11) to flow along the inner surface 192 of the separator housing inner wall 166 toward the oil outlets 86 so that the oil component 92 can then flow through the oil outlets 86 and into the oil sump 78.

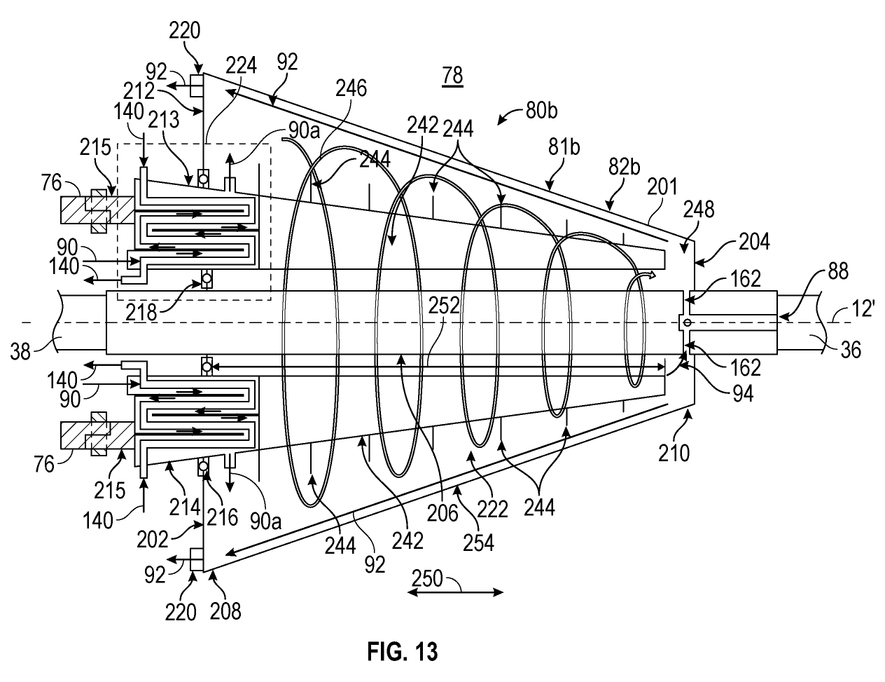

FIG. 13 is a side view of an alternate air-oil separation system 80b to the air-oil separation system 80 shown in FIG. 3, according to an aspect of the present disclosure. In FIG. 13, the alternate air-oil separation system 80b includes an alternate air-oil separator 81b that includes an alternate separator housing 82b, a first end wall 202, a second end wall 204, and a separator shaft 206. The alternate separator housing 82b includes a frusto-conical wall 201 that extends about the longitudinal centerline axis 12´, and the frusto-conical wall 201, the first end wall 202, and the second end wall 204 define a separation chamber 222. Unlike the frusto-conical wall 98 shown in FIG. 3, however, the frusto-conical wall 201 does not include the housing wall coolant flow passage 158. The first end wall 202 is arranged at a first end 208 of the frusto-conical wall 201, and the second end wall 204 is arranged at a second end 210 of the frusto-conical wall 201. The second end wall 204 is fixedly connected with the separator shaft 206 such that rotation of the separator shaft 206 rotates the second end wall 204 and the frusto-conical wall 201 about the longitudinal centerline axis 12´.

The first end wall 202 includes an outer first end wall portion 212 and an inner first end wall portion 214. At least one air-oil inlet portion 213, which will be described in more detail below, extends through the inner first end wall portion 214. Similar to the air-oil inlet portions 84 of the FIG. 3 aspect, a plurality of the air-oil inlet portions 213 may be included, and the plurality of air-oil inlet portions 213 may be circumferentially spaced apart from one another about the longitudinal centerline axis 12´ in a manner similar to the air-oil inlet portions 84 as shown in FIG. 5. The inner first end wall portion 214 is stationarily mounted with respect to the separator shaft 206, and is connected to the bearing support structure 76 (FIG. 2) via, for example, one or more bolted joints 215, so that the inner first end wall portion 214 does not rotate when the separator shaft 206 rotates. The separator shaft 206 is connected to the inner first end wall portion 214 via a bearing member 218 such that the bearing member 218 provides support for the separator shaft 206 to rotate about the longitudinal centerline axis 12´. The outer first end wall portion 212 is rotationally connected to the inner first end wall portion 214 via, for example, a bearing member 216. Thus, when the separator shaft 206 rotates, the outer first end wall portion 212, which is connected to the first end 208 of the frusto-conical wall 201, also rotates about the longitudinal centerline axis 12´.

The alternate air-oil separation system 80b further includes a plurality of oil outlets 220 arranged to extend through the outer first end wall portion 212. The plurality of oil outlets 220 may be the same as the plurality of oil outlets 86 of the FIG. 3 aspect, and may be circumferentially spaced apart from each other in the same manner as the oil outlets 86 as shown in FIG. 5.

The separator shaft 206, unlike the separator shaft 144 of the FIG. 3 aspect, omits the shaft coolant inlet portion 146 and the shaft coolant inlet channel 150, as well as the shaft coolant outlet portion 148 and the shaft coolant outlet channel 152. The separator shaft 206, however, includes the air outlet 88 and the air outlet passages 162. In the same manner described above for the FIG. 3 aspect, the air component 94 flows through the air outlet passage 162 and the air outlet 88 for the air component 94 to flow out of the separation chamber 222 to the vent 189 (FIG. 2).

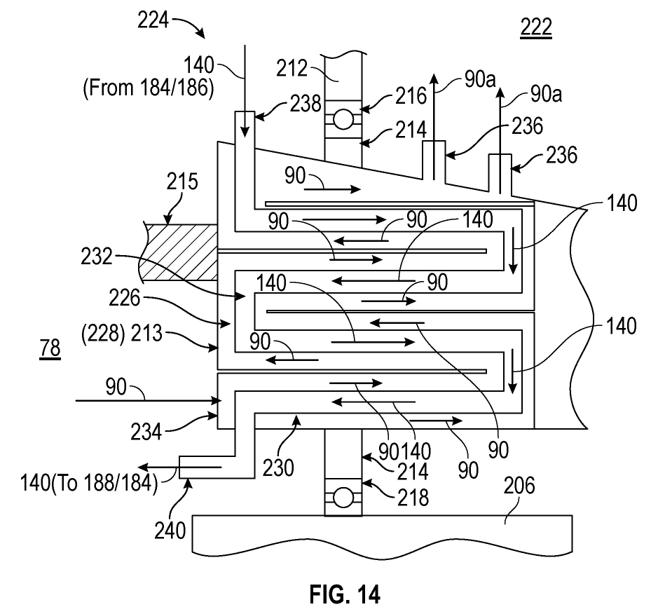

FIG. 14 is an enlarged, partial, cross-sectional, detail view of the air-oil inlet portion 213 of FIG. 13, taken at detail 224 of FIG. 13, according to an aspect of the present disclosure. The air-oil inlet portion 213 is fixedly connected to the inner first end wall portion 214, and extends through the inner first end wall portion 214. The air-oil inlet portion 213 includes an inlet heat exchanger portion 226, which, in the FIG. 14 aspect, is arranged as a counterflow heat exchanger 228. The counterflow heat exchanger 228 includes a serpentine oil flow passage 230 and a serpentine coolant flow passage 232 arranged within the serpentine oil flow passage 230. The serpentine oil flow passage 230 includes an oil inlet 234, and at least one oil outlet 236. The serpentine coolant flow passage 232 includes a coolant inlet 238 that is in fluid communication with the coolant supply line 186 (FIG. 2), and a coolant outlet 240 that is in fluid communication with the coolant return line 188 (FIG. 2). The oil inlet 234 is arranged to input the air-oil mixture 90 from the oil sump 78, and the at least one oil outlet 236 is arranged to output the cooled air-oil mixture 90a to the separation chamber 222. The air-oil mixture 90 flows through the serpentine oil flow passage 230 in a first direction, while the coolant 140 flows through the serpentine coolant flow passage 232 in a second direction opposite the first direction, thereby providing a counter flow of the air-oil mixture 90 with respect to the coolant 140. However, the present disclosure is not limited to a counter flow arrangement, and, in other embodiments (not illustrated), the air-oil mixture 90 flows in the same direction (i.e., a co-flow arrangement) as the flow of the coolant 140. The coolant 140 flowing through the serpentine coolant flow passage 232, therefore, provides cooling to the air-oil mixture 90 flowing through the serpentine oil flow passage 230 to obtain the cooled air-oil mixture 90a that is provided from the oil outlet 236 to the separation chamber 222. The counterflow heat exchanger 228 may be configured as a tubular heat exchanger, a plate heat exchanger, a finned heat exchanger, a monolithic unit cell-type heat exchanger, or any other suitable type of heat exchanger.

Returning to FIG. 13, the alternate air-oil separator 81b further includes a stationary swirler 242 extending from the air-oil inlet portion 213 into the separation chamber 222. The stationary swirler 242 may extend circumferentially about the longitudinal centerline axis 12´, or may include a plurality of stationary swirler portions that are circumferentially spaced apart about the longitudinal centerline axis 12´. The stationary swirler 242 extends into the separation chamber 222 in a lengthwise direction 250 by a distance 252 from the inner first end wall portion 214, such that a gap 248 is present between the stationary swirler 242 and the second end wall 204. The stationary swirler 242 also includes a plurality of vanes 244 arranged to induce a swirl 246 to the cooled air-oil mixture 90a within the separation chamber 222. The plurality of vanes 244 may extend circumferentially about the longitudinal centerline axis 12´, and may also be helical vanes that extend in the lengthwise direction 250. Thus, when the separation shaft 206 is driven to rotate by the LP rotor shaft 36, the alternate separator housing 82b rotates, and the cooled air-oil mixture 90a flows in the lengthwise direction 250, such that the plurality of vanes 244 induce the swirl 246 to the cooled air-oil mixture 90a within the separation chamber 222. In the same manner described above for the FIG. 3 aspect, the cooled air-oil mixture 90a is separated within the separation chamber 222 into the oil component 92 and into the air component 94. The air component 94 flows out of the separation chamber 222 via the air outlet 88 to the vent 189 (FIG. 2). The oil component 92 flows along an inner surface 254 of the frusto-conical wall 201 toward the plurality of oil outlets 220, and flows through the plurality of oil outlets 220 into the oil sump 78.

The present disclosure is not limited to the embodiments. In another embodiment (not illustrated) similar to the FIG. 13 aspect, wire mesh elements (similar to the wire mesh elements 196 in FIG. 11 and in FIG. 12) may be incorporated either along the stationary swirler 242 or along the frusto-conical wall 201 to further induce separation of the cooled air-oil mixture 90a. In addition, the air-oil separator 80 is not limited to having a frusto-conical shape as shown in FIGS. 2 through 13, but may have other suitable shapes instead, such as being cylindrical shaped.

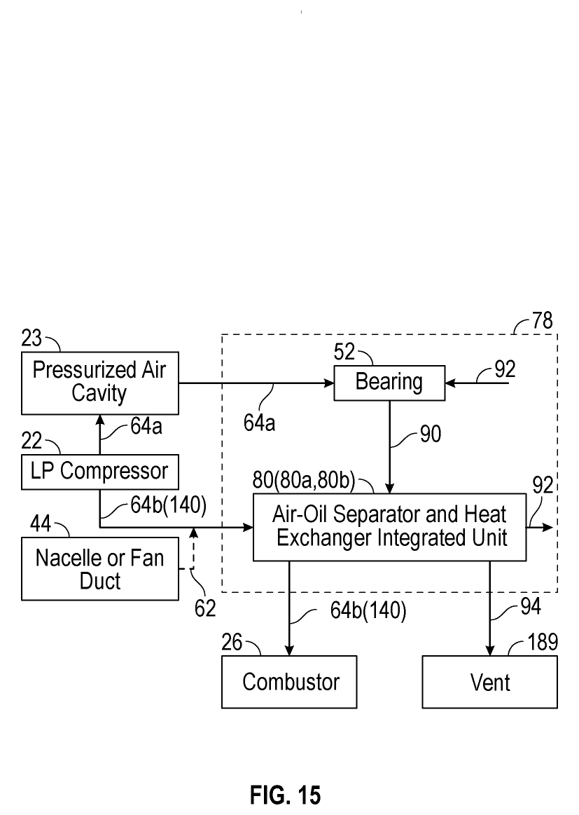

With each of the above aspects of FIG. 1 to FIG. 14, the coolant 140 may be comprised of any one of air, fuel, or oil. For example, in FIG. 2, the coolant supply source 184 may be a bleed air source within the engine 10. As another example, the coolant supply source 184 may be a fuel source (not shown) that provides a flow of fuel to the combustor 26. As another example, the coolant supply source 184 may be a flow of a cooled oil that has been cooled by a heat exchanger (not shown) in another part of the engine 10. However, other suitable coolant types such as supercritical carbon dioxide or liquid hydrogen fuel can be implemented instead. FIG. 15 to FIG. 17 are block diagrams depicting different architectures for a flow of the coolant 140 for each of the foregoing coolant sources.

FIG. 15 is a schematic, block diagram of an architecture for implementing an air-oil separation system 80 with air as the coolant 140, according to an aspect of the present disclosure. In FIG. 15, elements labeled with reference numerals that are the same as those included above for any of FIG. 1 to FIG. 14 are merely shown generally with a box for reference purposes. In the FIG. 15 architecture, the compressor bleed air 64a is provided from the LP compressor 22 to the pressurized air cavity 23. As described above with regard to FIG. 2, the shaft seals 85 and the shaft seals 87 seal the oil sump 78, but some leakage may occur through the shaft seals 85 and the shaft seals 87 so that some of the compressor bleed air 64a flows into the oil sump 78. The oil component 92 (e.g., the deaerated oil molecules) is provided to the LP shaft forward bearing 52 to lubricate the LP shaft forward bearing 52. The oil component 92 mixes with the compressor bleed air 64a (from the pressurized air cavity 23) near the shaft seals 85 and near the shaft seals 87 within the oil sump 78, resulting in the air-oil mixture 90. The air-oil mixture 90 is provided to the air-oil separation system 80 (or to the alternate air-oil separation system 80a, or to the alternate air-oil separation system 80b, depending on the system that is implemented), and, as was described above, the air-oil mixture 90 is processed by the air-oil separation system 80 to obtain the oil component 92 and the air component 94. In the FIG. 15 aspect, a compressor bleed air 64b is implemented as the coolant 140, and the compressor bleed air 64b is provided to the air-oil inlet portion 84 (FIG. 3) or to the air-oil inlet portion 213 (FIG. 14). The compressor bleed air 64b may be, for example, part of the compressor bleed air 64a that is provided to the pressurized air cavity, or may be provided from a different bleed air passage of the LP compressor 22 than a compressor bleed air passage (not shown) used for the compressor bleed air 64a. In operation, the compressor bleed air 64b provided to the air-oil inlet portion 84 or to the air-oil inlet portion 213, flows out of the air-oil inlet portion 84 or out of the air-oil inlet portion 213, and may be provided to the combustor 26. As was described above, in the air-oil separation system 80 (or the air-oil separation system 80a or the air-oil separation system 80b), the oil component 92 (e.g., the deaerated oil) is provided back to the oil sump 78, while the air component 94 (e.g., the deoiled air) is provided to the vent 189.

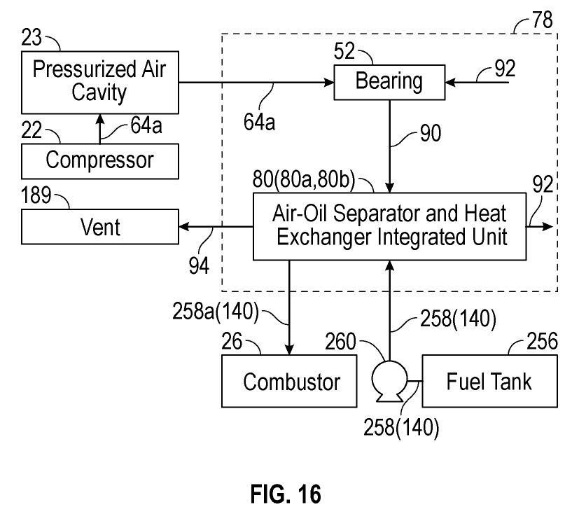

FIG. 16 is a schematic, block diagram of an architecture for implementing an air-oil separation system 80 with fuel as the coolant 140, according to an aspect of the present disclosure. In FIG. 16, elements labeled with reference numerals that are the same as those included above for any of FIG. 1 to FIG. 14 are merely shown generally with a box for reference purposes. In the FIG. 16 architecture, elements that are the same as those of the FIG. 15 aspect include the same reference numerals and the description provided above with regard to FIG. 15 of those elements is also applicable to the same elements in FIG. 16. In the FIG. 16 architecture, however, a fuel tank 256, which may be arranged on an aircraft (not shown) on which the engine 10 (FIG. 1) is mounted, holds a fuel 258 that is provided to the engine 10. The fuel 258 is generally provided to the combustor 26 (FIG. 1) for generating the combustion gases 68, but, the fuel 258 may also be used for other purposes within the engine 10. With regard to the architecture for the air-oil separation system 80 of FIG. 16, some of the fuel 258 may be provided from the fuel tank 256 to the air-oil separation system 80 (or the air-oil separation system 80a, or the air-oil separation system 80b) via a fuel pump 260. The fuel 258 is provided to the air-oil inlet portion 84 (FIG. 3), or to the air-oil inlet portion 213 of FIG. 13) as the coolant 140. In the air-oil separation system 80 (or the air-oil separation system 80a, or the air-oil separation system 80b), the fuel 258 flows through the air-oil inlet portion 84 to provide cooling to the air-oil mixture 90 flowing through the air-oil inlet portion 84. The air-oil separation system 80 (or the air-oil separation system 80a, or the air-oil separation system 80b), outputs the oil component 92 (e.g., the deaerated oil) to the oil sump 78, and provides the air component 94 (e.g., the deoiled air) to the vent 189. The fuel 258, which is heated in the air-oil separation system 80 to obtain a heated fuel 258a, may then be provided to the combustor 26 for use in combustion to generate the combustion gases 68.

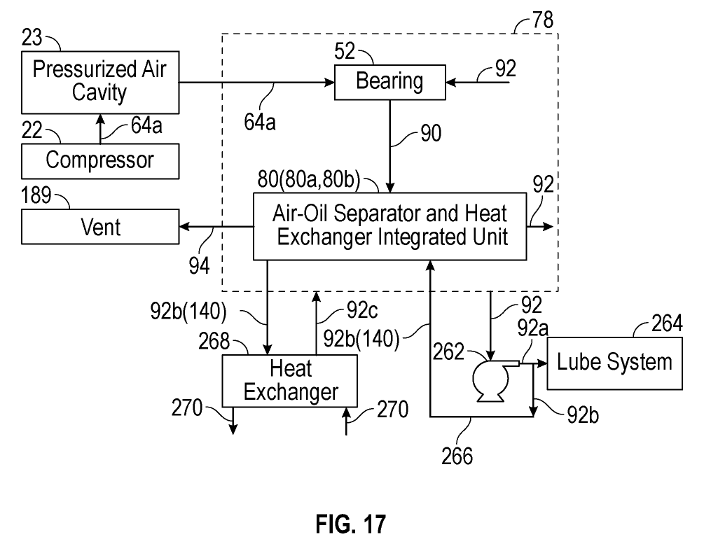

FIG. 17 is a schematic, block diagram of an architecture for implementing an air-oil separation system 80 with oil as the coolant 140, according to an aspect of the present disclosure. In FIG. 17, elements labeled with reference numerals that are the same as those included above for any of FIG. 1 to FIG. 14 are merely shown generally with a box for reference purposes. In the FIG. 17 architecture, elements that are the same as those of the FIG. 15 aspect include the same reference numerals and the description provided above with regard to FIG. 15 of those elements is also applicable to the same elements in FIG. 17. In the FIG. 17 architecture, however, the oil component 92 (e.g., the deaerated oil) from the oil sump 78 may be circulated through the air-oil separation system 80 (or the air-oil separation system 80a, or the air-oil separation system 80b) to be used as the coolant 140. In the architecture of FIG. 17, an oil pump 262 is connected to the oil sump 78 to obtain the oil component 92 from the oil sump 78. The oil component 92 may be provided, in part, as an oil component 92a to a lubrication system 264 of the engine 10. The oil component 92 is also provided to the air-oil separation system 80 (or the air-oil separation system 80a, or the air-oil separation system 80b) as a coolant oil component 92b via an oil supply line 266 to be used as the coolant 140. In the air-oil separation system 80 (or the air-oil separation system 80a, or the air-oil separation system 80b), the coolant oil component 92b flows through the air-oil inlet portion 84 to provide cooling to the air-oil mixture 90 flowing through the air-oil inlet portion 84. The air-oil separation system 80 (or the air-oil separation system 80a, or the air-oil separation system 80b), outputs the oil component 92 (e.g., the deaerated oil) to the oil sump 78, and provides the air component 94 (e.g., the deoiled air) to the vent 189. The coolant oil component 92b, which is heated in the air-oil separation system 80, may then be provided to a heat exchanger 268. The heat exchanger 268 utilizes a coolant source 270 to cool the coolant oil component 92b and outputs a cooled oil component 92c back to the oil sump 78.

As described above with regard to FIG. 1, the engine 10 may include the accessory gearbox 47, which may include one or more oil pumps. At least one of the one or more oil pumps may be fluidly connected to the oil sump 78, for example, to receive a flow of the oil from the oil sump 78 and to return a flow of the oil to the oil sump 78 in order to provide the lubrication to the LP shaft forward bearing 52. The one or more oil pumps may similarly be arranged to provide a flow of oil to lubricate the LP shaft aft bearing 50, the HP shaft aft bearing 54, and the HP shaft forward bearing 56. While the foregoing description of FIG. 2 relates to the oil sump 78 being arranged within the pressurized air cavity 23 for providing lubrication to the LP shaft forward bearing 52, similar arrangements of a pressurized air cavity, an oil sump, and an air-oil separation system as shown in FIG. 2 can also be provided for each of the LP shaft aft bearing 50, the HP shaft forward bearing 56, and the HP shaft aft bearing 54. That is, each of the LP shaft aft bearing 50, the HP shaft forward bearing 56, and the HP shaft aft bearing 54 may include an arrangement similar to the pressurized air cavity 23, the oil sump 78, and the air-oil separation system 80. Alternatively, a single air-oil separation system 80 may be provided for a shared oil sump. In such an arrangement, for example, an oil sump and air-oil separation system similar to that of FIG. 2 may be implemented to be driven by the accessory gearbox 47. An oil sump 78, without the air-oil separation system 80 as shown in FIG. 2, may be implemented for each of the LP shaft forward bearing 52, the LP shaft aft bearing 50, the HP shaft forward bearing 56, and the HP shaft aft bearing 54 so as to collect the oil that is pumped to the respective oil sump to lubricate each of the bearings. Each oil sump may be fluidly connected to the common oil sump so that the oil from each respective oil sump at the bearings flows to the common oil sump. Within the common oil sump, an arrangement of the air-oil separation system 80 may be included and may function in the same manner described above for the air-oil separation system 80 (or the alternate air-oil separation system 80a or the alternate air-oil separation system 80b). The oil component 92 within the common oil sump may then be pumped back to the respective oil sumps of the respective bearings, while the air component 94 is vented out of the common oil sump.

Each of the foregoing aspects provides an air-oil separation system that integrates a heat exchanger therewithin to cool the air-oil mixture that is input to the air-oil separation system. The air-oil separation system is also implemented within an oil sump, and utilizes the rotating spool shafts to drive the air-oil separation system. By integrating the heat exchanger within the air-oil separation system, a better separation process of the air-oil mixture can be obtained so that the deoiled air exiting the air-oil separation system has less oil contained therewithin. Thus, a reduction in oil consumption can be obtained. In addition, the deaeration of the oil by the air-oil separation system provides for better lubrication and cooling efficiency of the oil contained within the oil sump.

While the foregoing description relates generally to a gas turbine engine, the gas turbine engine may be implemented in various environments. For example, the engine may be implemented in an aircraft, but may so be implemented in non-aircraft applications, such as power generating stations, marine applications, or oil and gas production applications. Thus, the present disclosure is not limited to use in aircraft.

Further aspects of the present disclosure are provided by the subject matter of the following clauses.

An air-oil separation system for an oil sump in a gas turbine engine, the air-oil separation system including an air-oil separator arranged to separate an air-oil mixture into an oil component and into an air component, at least one air-oil inlet portion arranged to input the air-oil mixture from the oil sump into a separation chamber of the air-oil separator, the air-oil inlet portion including an inlet heat exchanger portion having an inlet coolant flow passage arranged to provide a flow of a coolant therethrough to cool the air-oil mixture input into the air-oil inlet portion, at least one oil outlet arranged to provide the oil component to flow from the separation chamber of the air-oil separator to the oil sump, and an air outlet arranged to provide the air component to flow out of the separation chamber of the air-oil separator.

The air-oil separation system according to the preceding clause, wherein the coolant is at least one of air, fuel, or oil.

The air-oil separation system according to any preceding clause, wherein the inlet heat exchanger is arranged as a counterflow heat exchanger in which the air-oil mixture flows in a first direction and the coolant flows in a second direction.

The air-oil separation system according to any preceding clause, wherein counterflow heat exchanger includes a serpentine coolant flow passage and a serpentine oil flow passage.

The air-oil separation system according to any preceding clause, wherein the counterflow heat exchanger is configured as any one of a tubular heat exchanger, a plate heat exchanger, a finned heat exchanger, a monolithic unit cell-type heat exchanger.

The air-oil separation system according to any preceding clause, wherein the air-oil separator comprises (a) a separator housing, (b) a first end wall, (c) a second end wall, and (d) a separator shaft, the separation chamber being defined between the separator housing, the first end wall, and the second end wall.

The air-oil separation system according to any preceding clause, wherein the air-oil separator is arranged to be rotationally driven by the separator shaft, and rotational driving of the air-oil separator causes the oil component to flow along an inner surface of the separator housing and to flow out of the at least one oil outlet into the oil sump.

The air-oil separation system according to any preceding clause, wherein the air-oil separator further includes at least one wire mesh element extending from the air-oil inlet portion into the separation chamber, the at least one wire mesh element being arranged to atomize the air-oil mixture within the separation chamber.

The air-oil separation system according to any preceding clause, wherein (i) the first end wall includes an outer first end wall portion fixedly connected to the separator housing, and an inner first end wall portion fixedly connected to a support structure to which the air-oil separation system is mounted, (ii) the second end wall is fixedly connected to the separator housing and to the separator shaft, the separator shaft being arranged to rotationally drive the second end wall, the separator housing, and the outer first end wall portion about a longitudinal centerline axis of the air-oil separation system, and the inner first end wall portion being stationarily mounted with respect to the separator shaft, the at least one air-oil inlet portion being arranged to extend through the inner first end wall portion, and the at least one oil outlet being arranged to extend through the outer first end wall portion.

The air-oil separation system according to any preceding clause, wherein the separator housing includes a frusto-conical wall extending about a longitudinal centerline axis of the separator housing, the first end wall being arranged on a first end of the frusto-conical wall and including an outer first end wall portion and an inner first end wall portion, and the second end wall being arranged on a second end of the frusto-conical wall, the inner first end wall portion being stationarily mounted with respect to the separator shaft and the outer first end wall portion being rotationally connected with the inner first end wall portion, the at least one air-oil inlet portion being connected to the inner first end wall portion.

The air-oil separation system according to any preceding clause, wherein the air-oil separation system further includes a stationary swirler extending from the air-oil inlet portion into the separation chamber.

The air-oil separation system according to any preceding clause, wherein the stationary swirler includes a plurality of vanes arranged to induce a swirl to the air-oil mixture within the separation chamber.

The air-oil separation system according to any preceding clause, wherein the separator housing includes a frusto-conical wall that includes at least one housing wall coolant flow passage within the frusto-conical wall and being arranged to provide a flow of the coolant therethrough to provide cooling to the air-oil mixture within the separation chamber.

The air-oil separation system according to any preceding clause, wherein the at least one housing wall coolant flow passage includes a plurality of housing coolant flow channels.

The air-oil separation system according to any preceding clause, wherein the frusto-conical wall includes a separator housing outer wall and a separator housing inner wall, the at least one housing wall coolant flow passage being defined between the separator housing outer wall and the separator housing inner wall, and a plurality of heat exchange elements are arranged within the at least one housing wall coolant flow passage.

The air-oil separation system according to any preceding clause, wherein the plurality of heat exchange elements are heat exchange posts that are connected to the separator housing outer wall and to the separator housing inner wall.

The air-oil separation system according to any preceding clause, wherein the plurality of heat exchange posts are spaced apart from each other within the single housing wall coolant flow passage in a circumferential direction with respect to the longitudinal centerline axis.

The air-oil separation system according to any preceding clause, wherein the plurality of heat exchange elements are heat exchange blocks (or unit cells) that are connected to the separator housing outer wall and to the separator housing inner wall.

The air-oil separation system according to any preceding clause, wherein each of the plurality of heat exchange blocks include a coolant flow passages therethrough.

The air-oil separation system according to any preceding clause, wherein the plurality of heat exchange blocks are spaced apart from each other within the single housing wall coolant flow passage in a circumferential direction with respect to the longitudinal centerline axis.

The air-oil separation system according to any preceding clause, wherein the housing wall coolant flow passage includes a plurality of housing coolant flow channels.

The air-oil separation system according to any preceding clause, wherein the plurality of housing coolant flow channels includes a plurality of inner housing coolant flow channels and a plurality of outer housing coolant flow channels.

The air-oil separation system according to any preceding clause, wherein the frusto-conical wall includes a vane structure on an inner surface of the frusto-conical wall, the vane structure being arranged to generate a swirl in the air-oil mixture within the separation chamber.

The air-oil separation system according to any preceding clause, wherein the first end wall is arranged at a first end of the frusto-conical wall, and the second end wall is arranged at a second end of the frusto-conical wall, the at least one air-oil inlet portion and the at least one oil outlet being arranged through the first end wall.

The air-oil separation system according to any preceding clause, wherein the first end wall has a first diameter and the second end wall has a second diameter less than the first diameter, and the at least one oil outlet comprises a plurality of oil outlets arranged through the first end wall adjacent to the first end of the frusto-conical wall.

The air-oil separation system according to any preceding clause, wherein the first end wall includes at least one first end wall coolant flow passage therewithin, the at least one first end wall coolant flow passage being in fluid communication with the inlet coolant flow passage of each air-oil inlet, and in fluid communication with the at least one housing wall coolant flow passage of the frusto-conical wall.

The air-oil separation system according to any preceding clause, wherein the second end wall includes at least one second end wall coolant flow passage therewithin, the at least one second end wall coolant flow passage being in fluid communication with the at least one housing wall coolant flow passage.

The air-oil separation system according to any preceding clause, wherein the separator shaft includes a shaft coolant inlet portion and a shaft coolant outlet portion, the shaft coolant inlet portion being in fluid communication with the at least one first end wall coolant flow passage to provide a flow of the coolant thereto, and the shaft coolant outlet portion being in fluid communication with the at least one second end wall coolant flow passage to receive a flow of the coolant therefrom.

The air-oil separation system according to any preceding clause, wherein the separator shaft further includes at least one air outlet passage in fluid communication with the separation chamber of the air-oil separator, and arranged to provide a flow of the air component to flow out of the separation chamber.

The air-oil separation system according to any preceding clause, wherein, in operation, (i) the air-oil separator is driven by the separator shaft to rotate, (ii) the air-oil mixture flows from the oil sump through the air-oil inlet portion into the separation chamber, and the air-oil mixture is cooled by the coolant flowing through the inlet coolant flow passage, (iii) the air-oil mixture is swirled within the separation chamber to separate the air-oil mixture to obtain the oil component and to obtain the air component, (iv) the oil component flows along a surface of the separator housing toward the at least one oil outlet and the oil component is further cooled by the coolant flowing through the at least one housing wall coolant flow passage, (v) the oil component flows through the at least one oil outlet to flow out of the separation chamber and into the oil sump, and (vi) the air component flows through the at least one air outlet passage to flow out of the separation chamber.

A gas turbine engine including a high pressure spool including a high pressure compressor and a high pressure turbine connected via a high pressure shaft and supported by high pressure shaft bearings, a low pressure spool including a low pressure compressor and a low pressure turbine connected via a low pressure shaft and supported by low pressure bearings, at least one oil sump providing oil lubrication to at least one of the high pressure bearings and to the low pressure bearings, and at least one air-oil separation system provided in the at least one oil sump, the at least one air-oil separation system including an air-oil separator arranged to separate an air-oil mixture into an oil component and into an air component, at least one air-oil inlet portion arranged to input the air-oil mixture from the oil sump into a separation chamber of the air-oil separator, the air-oil inlet portion including an inlet heat exchanger portion having an inlet coolant flow passage arranged to provide a flow of a coolant therethrough to cool the air-oil mixture input into the air-oil inlet portion, at least one oil outlet arranged to provide the oil component to flow from the separation chamber of the air-oil separator to the oil sump, and an air outlet arranged to provide the air component to flow out of the separation chamber of the air-oil separator.

The gas turbine engine according to the preceding clause, wherein the coolant is at least one of air, fuel, or oil.

The gas turbine engine according to any preceding clause, wherein the inlet heat exchanger is arranged as a counterflow heat exchanger in which the air-oil mixture flows in a first direction and the coolant flows in a second direction.

The gas turbine engine according to any preceding clause, wherein counterflow heat exchanger includes a serpentine coolant flow passage and a serpentine oil flow passage.

The gas turbine engine according to any preceding clause, wherein the counterflow heat exchanger is configured as any one of a tubular heat exchanger, a plate heat exchanger, a finned heat exchanger, a monolithic unit cell-type heat exchanger.

The gas turbine engine according to any preceding clause, wherein the air-oil separator comprises (a) a separator housing, (b) a first end wall, (c) a second end wall, and (d) a separator shaft, the separation chamber being defined between the separator housing, the first end wall, and the second end wall.

The gas turbine engine according to any preceding clause, wherein the air-oil separator is arranged to be rotationally driven by the separator shaft, and rotational driving of the air-oil separator causes the oil component to flow along an inner surface of the separator housing and to flow out of the at least one oil outlet into the oil sump.

The gas turbine engine according to any preceding clause, wherein the air-oil separator further includes at least one wire mesh element extending from the air-oil inlet portion into the separation chamber, the at least one wire mesh element being arranged to atomize the air-oil mixture within the separation chamber.

The gas turbine engine according to any preceding clause, wherein (i) the first end wall includes an outer first end wall portion fixedly connected to the separator housing, and an inner first end wall portion fixedly connected to a support structure to which the air-oil separation system is mounted, (ii) the second end wall is fixedly connected to the separator housing and to the separator shaft, the separator shaft being arranged to rotationally drive the second end wall, the separator housing, and the outer first end wall portion about a longitudinal centerline axis of the air-oil separation system, and the inner first end wall portion being stationarily mounted with respect to the separator shaft, the at least one air-oil inlet portion being arranged to extend through the inner first end wall portion, and the at least one oil outlet being arranged to extend through the outer first end wall portion.

The gas turbine engine according to any preceding clause, wherein the separator housing includes a frusto-conical wall extending about a longitudinal centerline axis of the separator housing, the first end wall being arranged on a first end of the frusto-conical wall and including an outer first end wall portion and an inner first end wall portion, and the second end wall being arranged on a second end of the frusto-conical wall, the inner first end wall portion being stationarily mounted with respect to the separator shaft and the outer first end wall portion being rotationally connected with the inner first end wall portion, the at least one air-oil inlet portion being connected to the inner first end wall portion.

The gas turbine engine according to any preceding clause, wherein the air-oil separation system further includes a stationary swirler extending from the air-oil inlet portion into the separation chamber.

The gas turbine engine according to any preceding clause, wherein the stationary swirler includes a plurality of vanes arranged to induce a swirl to the air-oil mixture within the separation chamber.

The gas turbine engine according to any preceding clause, wherein the separator housing includes a frusto-conical wall that includes at least one housing wall coolant flow passage within the frusto-conical wall and being arranged to provide a flow of the coolant therethrough to provide cooling to the air-oil mixture within the separation chamber.

The gas turbine engine according to any preceding clause, wherein the at least one housing wall coolant flow passage includes a plurality of housing coolant flow channels.

The gas turbine engine according to any preceding clause, wherein the frusto-conical wall includes a separator housing outer wall and a separator housing inner wall, the at least one housing wall coolant flow passage being defined between the separator housing outer wall and the separator housing inner wall, and a plurality of heat exchange elements are arranged within the at least one housing wall coolant flow passage.

The gas turbine engine according to any preceding clause, wherein the plurality of heat exchange elements are heat exchange posts that are connected to the separator housing outer wall and to the separator housing inner wall.

The gas turbine engine according to any preceding clause, wherein the plurality of heat exchange posts are spaced apart from each other within the single housing wall coolant flow passage in a circumferential direction with respect to the longitudinal centerline axis.

The gas turbine engine according to any preceding clause, wherein the plurality of heat exchange elements are heat exchange blocks (or unit cells) that are connected to the separator housing outer wall and to the separator housing inner wall.

The gas turbine engine according to any preceding clause, wherein each of the plurality of heat exchange blocks include a coolant flow passages therethrough.

The gas turbine engine according to any preceding clause, wherein the plurality of heat exchange blocks are spaced apart from each other within the single housing wall coolant flow passage in a circumferential direction with respect to the longitudinal centerline axis.

The gas turbine engine according to any preceding clause, wherein the housing wall coolant flow passage includes a plurality of housing coolant flow channels.

The gas turbine engine according to any preceding clause, wherein the plurality of housing coolant flow channels includes a plurality of inner housing coolant flow channels and a plurality of outer housing coolant flow channels.

The gas turbine engine according to any preceding clause, wherein the frusto-conical wall includes a vane structure on an inner surface of the frusto-conical wall, the vane structure being arranged to generate a swirl in the air-oil mixture within the separation chamber.

The gas turbine engine according to any preceding clause, wherein the first end wall is arranged at a first end of the frusto-conical wall, and the second end wall is arranged at a second end of the frusto-conical wall, the at least one air-oil inlet portion and the at least one oil outlet being arranged through the first end wall.

The gas turbine engine according to any preceding clause, wherein the first end wall has a first diameter and the second end wall has a second diameter less than the first diameter, and the at least one oil outlet comprises a plurality of oil outlets arranged through the first end wall adjacent to the first end of the frusto-conical wall.

The gas turbine engine according to any preceding clause, wherein the first end wall includes at least one first end wall coolant flow passage therewithin, the at least one first end wall coolant flow passage being in fluid communication with the inlet coolant flow passage of each air-oil inlet, and in fluid communication with the at least one housing wall coolant flow passage of the frusto-conical wall.

The gas turbine engine according to any preceding clause, wherein the second end wall includes at least one second end wall coolant flow passage therewithin, the at least one second end wall coolant flow passage being in fluid communication with the at least one housing wall coolant flow passage.

The gas turbine engine according to any preceding clause, wherein the separator shaft includes a shaft coolant inlet portion and a shaft coolant outlet portion, the shaft coolant inlet portion being in fluid communication with the at least one first end wall coolant flow passage to provide a flow of the coolant thereto, and the shaft coolant outlet portion being in fluid communication with the at least one second end wall coolant flow passage to receive a flow of the coolant therefrom.

The gas turbine engine according to any preceding clause, wherein the separator shaft further includes at least one air outlet passage in fluid communication with the separation chamber of the air-oil separator, and arranged to provide a flow of the air component to flow out of the separation chamber.

The gas turbine engine according to any preceding clause, wherein, in operation, (i) the air-oil separator is driven by the separator shaft to rotate, (ii) the air-oil mixture flows from the oil sump through the air-oil inlet portion into the separation chamber, and the air-oil mixture is cooled by the coolant flowing through the inlet coolant flow passage, (iii) the air-oil mixture is swirled within the separation chamber to separate the air-oil mixture to obtain the oil component and to obtain the air component, (iv) the oil component flows along a surface of the separator housing toward the at least one oil outlet and the oil component is further cooled by the coolant flowing through the at least one housing wall coolant flow passage, (v) the oil component flows through the at least one oil outlet to flow out of the separation chamber and into the oil sump, and (vi) the air component flows through the at least one air outlet passage to flow out of the separation chamber.

A gas turbine engine including a high pressure spool including a high pressure compressor and a high pressure turbine connected via a high pressure shaft and supported by high pressure shaft bearings, a low pressure spool including a low pressure compressor and a low pressure turbine connected via a low pressure shaft and supported by low pressure bearings, a high pressure oil sump providing oil lubrication to the high pressure bearings, a low pressure oil sump providing oil lubrication to the low pressure bearings, an accessory gearbox driven by the high pressure spool, a main oil sump providing oil lubrication to the accessory gearbox, being driven by the accessory gearbox, and being in fluid communication with the high pressure oil sump and with the low pressure oil sump, the main oil sump including an air-oil separation system including an air-oil separator arranged to separate an air-oil mixture into an oil component and into an air component, at least one air-oil inlet portion arranged to input the air-oil mixture from the oil sump into a separation chamber of the air-oil separator, the air-oil inlet portion including an inlet heat exchanger portion having an inlet coolant flow passage arranged to provide a flow of a coolant therethrough to cool the air-oil mixture input into the air-oil inlet portion, at least one oil outlet arranged to provide the oil component to flow from the separation chamber of the air-oil separator to the oil sump, and an air outlet arranged to provide the air component to flow out of the separation chamber of the air-oil separator.

The gas turbine engine according to the preceding clause, wherein the coolant is at least one of air, fuel, or oil.

The gas turbine engine according to any preceding clause, wherein the air-oil separator comprises (a) a separator housing, (b) a first end wall, (c) a second end wall, and (d) a separator shaft, the separation chamber being defined between the separator housing, the first end wall, and the second end wall.

The gas turbine engine according to any preceding clause, wherein the air-oil separator is arranged to be rotationally driven by the separator shaft, and rotational driving of the air-oil separator causes the oil component to flow along an inner surface of the separator housing and to flow out of the at least one oil outlet into the oil sump.

The gas turbine engine according to any preceding clause, wherein the air-oil separator further includes at least one wire mesh element extending from the air-oil inlet portion into the separation chamber, the at least one wire mesh element being arranged to atomize the air-oil mixture within the separation chamber.

The gas turbine engine according to any preceding clause, wherein (i) the first end wall includes an outer first end wall portion fixedly connected to the separator housing, and an inner first end wall portion fixedly connected to a support structure to which the air-oil separation system is mounted, (ii) the second end wall is fixedly connected to the separator housing and to the separator shaft, the separator shaft being arranged to rotationally drive the second end wall, the separator housing, and the outer first end wall portion about a longitudinal centerline axis of the air-oil separation system, and the inner first end wall portion being stationarily mounted with respect to the separator shaft, the at least one air-oil inlet portion being arranged to extend through the inner first end wall portion, and the at least one oil outlet being arranged to extend through the outer first end wall portion.

The gas turbine engine according to any preceding clause, wherein the separator housing includes a frusto-conical wall extending about a longitudinal centerline axis of the separator housing, the first end wall being arranged on a first end of the frusto-conical wall and including an outer first end wall portion and an inner first end wall portion, and the second end wall being arranged on a second end of the frusto-conical wall, the inner first end wall portion being stationarily mounted with respect to the separator shaft and the outer first end wall portion being rotationally connected with the inner first end wall portion, the at least one air-oil inlet portion being connected to the inner first end wall portion.

The gas turbine engine according to any preceding clause, wherein the air-oil separation system further includes a stationary swirler extending from the air-oil inlet portion into the separation chamber.

The gas turbine engine according to any preceding clause, wherein the stationary swirler includes a plurality of vanes arranged to induce a swirl to the air-oil mixture within the separation chamber.

The gas turbine engine according to any preceding clause, wherein the separator housing includes a frusto-conical wall that includes at least one housing wall coolant flow passage within the frusto-conical wall and being arranged to provide a flow of the coolant therethrough to provide cooling to the air-oil mixture within the separation chamber.

The gas turbine engine according to any preceding clause, wherein the at least one housing wall coolant flow passage includes a plurality of housing coolant flow channels.

The gas turbine engine according to any preceding clause, wherein the frusto-conical wall includes a separator housing outer wall and a separator housing inner wall, the at least one housing wall coolant flow passage being defined between the separator housing outer wall and the separator housing inner wall, and a plurality of heat exchange elements are arranged within the at least one housing wall coolant flow passage.

The gas turbine engine according to any preceding clause, wherein the frusto-conical wall includes a vane structure on an inner surface of the frusto-conical wall, the vane structure being arranged to generate a swirl in the air-oil mixture within the separation chamber.

The gas turbine engine according to any preceding clause, wherein the first end wall is arranged at a first end of the frusto-conical wall, and the second end wall is arranged at a second end of the frusto-conical wall, the at least one air-oil inlet portion and the at least one oil outlet being arranged through the first end wall.

The gas turbine engine according to any preceding clause, wherein the first end wall has a first diameter and the second end wall has a second diameter less than the first diameter, and the at least one oil outlet comprises a plurality of oil outlets arranged through the first end wall adjacent to the first end of the frusto-conical wall.

The gas turbine engine according to any preceding clause, wherein the first end wall includes at least one first end wall coolant flow passage therewithin, the at least one first end wall coolant flow passage being in fluid communication with the inlet coolant flow passage of each air-oil inlet, and in fluid communication with the at least one housing wall coolant flow passage of the frusto-conical wall.

The gas turbine engine according to any preceding clause, wherein the second end wall includes at least one second end wall coolant flow passage therewithin, the at least one second end wall coolant flow passage being in fluid communication with the at least one housing wall coolant flow passage.

The gas turbine engine according to any preceding clause, wherein the separator shaft includes a shaft coolant inlet portion and a shaft coolant outlet portion, the shaft coolant inlet portion being in fluid communication with the at least one first end wall coolant flow passage to provide a flow of the coolant thereto, and the shaft coolant outlet portion being in fluid communication with the at least one second end wall coolant flow passage to receive a flow of the coolant therefrom.

The gas turbine engine according to any preceding clause, wherein the separator shaft further includes at least one air outlet passage in fluid communication with the separation chamber of the air-oil separator, and arranged to provide a flow of the air component to flow out of the separation chamber.

The gas turbine engine according to any preceding clause, wherein, in operation, (i) the air-oil separator is driven by the separator shaft to rotate, (ii) the air-oil mixture flows from the oil sump through the air-oil inlet portion into the separation chamber, and the air-oil mixture is cooled by the coolant flowing through the inlet coolant flow passage, (iii) the air-oil mixture is swirled within the separation chamber to separate the air-oil mixture to obtain the oil component and to obtain the air component, (iv) the oil component flows along a surface of the separator housing toward the at least one oil outlet and the oil component is further cooled by the coolant flowing through the at least one housing wall coolant flow passage, (v) the oil component flows through the at least one oil outlet to flow out of the separation chamber and into the oil sump, and (vi) the air component flows through the at least one air outlet passage to flow out of the separation chamber.

Although the foregoing description is directed to some exemplary embodiments of the present disclosure, other variations and modifications will be apparent to those skilled in the art, and may be made without departing from the present disclosure. Moreover, features described in connection with one embodiment of the present disclosure may be used in conjunction with other embodiments, even if not explicitly stated above.

We claim:

1. An air-oil separation system for an oil sump in a gas turbine engine, the air-oil separation system comprising:
an air-oil separator arranged to separate an air-oil mixture into an oil component and into an air component;
at least one air-oil inlet portion arranged to input the air-oil mixture from the oil sump into a separation chamber of the air-oil separator, the air-oil inlet portion including an inlet heat exchanger portion having an inlet coolant flow passage arranged to provide a flow of a coolant therethrough to cool the air-oil mixture input into the air-oil inlet portion;
at least one oil outlet arranged to provide the oil component to flow from the separation chamber of the air-oil separator to the oil sump; and
an air outlet arranged to provide the air component to flow out of the separation chamber of the air-oil separator.

2. The air-oil separation system according to claim 1, wherein the coolant is at least one of air, fuel, or oil.

3. The air-oil separation system according to claim 1, wherein the air-oil separator comprises (a) a separator housing, (b) a first end wall, (c) a second end wall, and (d) a separator shaft, the separation chamber being defined between the separator housing, the first end wall, and the second end wall.

4. The air-oil separation system according to claim 3, wherein the air-oil separator is arranged to be rotationally driven by the separator shaft, and rotational driving of the air-oil separator causes the oil component to flow along an inner surface of the separator housing and to flow out of the at least one oil outlet into the oil sump.

5. The air-oil separation system according to claim 3, wherein the air-oil separator further includes at least one wire mesh element extending from the air-oil inlet portion into the separation chamber, the at least one wire mesh element being arranged to atomize the air-oil mixture within the separation chamber.

6. The air-oil separation system according to claim 3, wherein (i) the first end wall includes an outer first end wall portion fixedly connected to the separator housing, and an inner first end wall portion fixedly connected to a support structure to which the air-oil separation system is mounted, (ii) the second end wall is fixedly connected to the separator housing and to the separator shaft, the separator shaft being arranged to rotationally drive the second end wall, the separator housing, and the outer first end wall portion about a longitudinal centerline axis of the air-oil separation system, and the inner first end wall portion being stationarily mounted with respect to the separator shaft, the at least one air-oil inlet portion being arranged to extend through the inner first end wall portion, and the at least one oil outlet being arranged to extend through the outer first end wall portion.

7. The air-oil separation system according to claim 3, wherein the separator housing includes a frusto-conical wall extending about a longitudinal centerline axis of the separator housing, the first end wall being arranged on a first end of the frusto-conical wall and including an outer first end wall portion and an inner first end wall portion, and the second end wall being arranged on a second end of the frusto-conical wall, the inner first end wall portion being stationarily mounted with respect to the separator shaft and the outer first end wall portion being rotationally connected with the inner first end wall portion, the at least one air-oil inlet portion being connected to the inner first end wall portion.

8. The air-oil separation system according to claim 7, wherein the air-oil separation system further includes a stationary swirler extending from the air-oil inlet portion into the separation chamber.

9. The air-oil separation system according to claim 8, wherein the stationary swirler includes a plurality of vanes arranged to induce a swirl to the air-oil mixture within the separation chamber.

10. The air-oil separation system according to claim 3, wherein the separator housing includes a frusto-conical wall that includes at least one housing wall coolant flow passage within the frusto-conical wall and being arranged to provide a flow of the coolant therethrough to provide cooling to the air-oil mixture within the separation chamber.

11. The air-oil separation system according to claim 10, wherein the at least one housing wall coolant flow passage includes a plurality of housing coolant flow channels.

12. The air-oil separation system according to claim 10, wherein the frusto-conical wall includes a separator housing outer wall and a separator housing inner wall, the at least one housing wall coolant flow passage being defined between the separator housing outer wall and the separator housing inner wall, and a plurality of heat exchange elements are arranged within the at least one housing wall coolant flow passage.

13. The air-oil separation system according to claim 10, wherein the frusto-conical wall includes a vane structure on an inner surface of the frusto-conical wall, the vane structure being arranged to generate a swirl in the air-oil mixture within the separation chamber.

14. The air-oil separation system according to claim 10, wherein the first end wall is arranged at a first end of the frusto-conical wall, and the second end wall is arranged at a second end of the frusto-conical wall, the at least one air-oil inlet portion and the at least one oil outlet being arranged through the first end wall.

15. The air-oil separation system according to claim 14, wherein the first end wall has a first diameter and the second end wall has a second diameter less than the first diameter, and the at least one oil outlet comprises a plurality of oil outlets arranged through the first end wall adjacent to the first end of the frusto-conical wall.

16. The air-oil separation system according to claim 14, wherein the first end wall includes at least one first end wall coolant flow passage therewithin, the at least one first end wall coolant flow passage being in fluid communication with the inlet coolant flow passage of each air-oil inlet, and in fluid communication with the at least one housing wall coolant flow passage of the frusto-conical wall.

17. The air-oil separation system according to claim 16, wherein the second end wall includes at least one second end wall coolant flow passage therewithin, the at least one second end wall coolant flow passage being in fluid communication with the at least one housing wall coolant flow passage.

18. The air-oil separation system according to claim 17, wherein the separator shaft includes a shaft coolant inlet portion and a shaft coolant outlet portion, the shaft coolant inlet portion being in fluid communication with the at least one first end wall coolant flow passage to provide a flow of the coolant thereto, and the shaft coolant outlet portion being in fluid communication with the at least one second end wall coolant flow passage to receive a flow of the coolant therefrom.

19. The air-oil separation system according to claim 18, wherein the separator shaft further includes at least one air outlet passage in fluid communication with the separation chamber of the air-oil separator, and arranged to provide a flow of the air component to flow out of the separation chamber.

20. The air-oil separation system according to claim 19, wherein, in operation, (i) the air-oil separator is driven by the separator shaft to rotate, (ii) the air-oil mixture flows from the oil sump through the air-oil inlet portion into the separation chamber, and the air-oil mixture is cooled by the coolant flowing through the inlet coolant flow passage, (iii) the air-oil mixture is swirled within the separation chamber to separate the air-oil mixture to obtain the oil component and to obtain the air component, (iv) the oil component flows along a surface of the separator housing toward the at least one oil outlet and the oil component is further cooled by the coolant flowing through the at least one housing wall coolant flow passage, (v) the oil component flows through the at least one oil outlet to flow out of the separation chamber and into the oil sump, and (vi) the air component flows through the at least one air outlet passage to flow out of the separation chamber.
